(19) United States
(12) Patent Application Publication
(10) Pub. No.: US 2014/0060880 A1
(43) Pub. Date: Mar. 6, 2014

(54) PROTECTOR OF ELECTRIC WIRE FOR ALLOWING MOVEMENT OF FIXATION OBJECT

(71) Applicants: Hiroki Gotou, Shizuoka (JP); Masafumi Nakayasu, Shizuoka (JP); Kaoru Suzuki, Aichi (JP); Kazuhiro Kusuyama, Aichi (JP); Hiroyuki Uno, Aichi (JP)

(72) Inventors: Hiroki Gotou, Shizuoka (JP); Masafumi Nakayasu, Shizuoka (JP); Kaoru Suzuki, Aichi (JP); Kazuhiro Kusuyama, Aichi (JP); Hiroyuki Uno, Aichi (JP)

(73) Assignee: YAZAKI CORPORATION, Tokyo (JP)

(21) Appl. No.: 14/110,971

(22) PCT Filed: Apr. 20, 2012
(86) PCT No.: PCT/JP2012/061304

§ 371 Date: Oct. 10, 2013

(30) Foreign Application Priority Data
Apr. 22, 2011 (JP) 2011-095820

(51) Int. Cl. H02G 3/04

(52) U.S. Cl. CPC H02G 3/0406
USPC 174/68.3

(57) ABSTRACT

There is provided a protector to be assembled and fixed to a given position of a fixation object. The protector includes an accommodating space and an opening consecutive to the accommodating space which an electric wire or a bundle of electric wires is adapted to be passed through and accommodated in. The accommodating space includes an excessive part accommodating space which accommodates an excessive part of the electric wire or the bundle of electric wires.

### TECHNICAL FIELD

The present invention relates to a protector which an electric wire or a bundle of electric wires is passed through and accommodated in and which is assembled and fixed to a predetermined position of a fixation object.

### BACKGROUND ART

A wire harness is arranged in a vehicle such as an automobile. The wire harness includes an electric wire or a bundle of electric wires. The wire harness is adapted to supply electricity from a battery to in-vehicle devices and electrically connected between the devices. Such a wire harness is provided with a protector. The protector is assembled and fixed to a predetermined position of a fixation object in the vehicle, and is adapted to regulate the arranging path of the wire harness and protect the wire harness.

The protector in a related art is adapted to be assembled and fixed to the predetermined position after the electric wire or the bundle of electric wires is passed through and accommodated in the protector and the electric wire or the bundle of electric wires is not movable (refer to, for example, Patent Literature 1).

### CITATION LIST

### Patent Literature

Patent Literature 1: JP-A-8-256415

### SUMMARY OF INVENTION

### Technical Problem

The electric wire or the bundle of electric wires which is passed through and accommodated in the protector in the related art is not movable, and the electric wire or the bundle of electric wires is not given an excessive part. Accordingly, for example, even when the fixation object for the protector is to be moved due to a vehicle crash, the electric wire or the bundle of electric wires is strained in a direction of preventing the movement. As a result, there is a problem that a force due to the vehicle crash is applied on the fixation object, and the fixation object is damaged.

In view of the above-mentioned problems, an object of the present invention is to provide a protector for which a fixation object can be moved, for example, due to a vehicle crash.

### Solution to Problem

According to a first aspect of the present invention, there is provided a protector to be assembled and fixed to a given position of a fixation object, the protector including: an accommodating space and an opening consecutive to the accommodating space which an electric wire or a bundle of electric wires is adapted to be passed through and accommodated in, wherein the accommodating space includes an excessive part accommodating space which accommodates an excessive part of the electric wire or the bundle of electric wires.

According to a second aspect of the present invention, the protector may be configured so that a breakable part or a deformable part which is broken or deformed when being pushed by the electric wire or the bundle of the electric wires is provided in proximity to the opening which allows the excessive part to be drawn out from the excessive part accommodating space.

According to a third aspect of the present invention, the protector may be configured so that the breakable part or the deformable part is broken or deformed while serving as a hinge when being pushed by the electric wire or the bundle of the electric wires.

According to a fourth aspect of the present invention, the protector may be configured so that the breakable part or the deformable part is provided with a flange.

### Advantageous Effects of Invention

According to the first aspect of the present invention, since the protector has the excessive part accommodating space in which the excessive part of the electric wire or the bundle of electric wires can be accommodated, and the excessive part accommodated in the excessive part accommodating space of the protector can be drawn out, the fixation object can be moved, for example, at the time of a vehicle crash. Therefore, an effect of relieving the damage to the fixation object can be achieved.

According to the second aspect of the present invention, since the breakable part or the deformable part is provided which is broken or deformed if an external force is received, the fixation object can be further moved for the length of the breakage or the deformation, or the excessive part can be shorten for the length of the breakage or the deformation (in the case that the excessive part is shorten, the material and the weight of the electric wire can be reduced).

According to the third aspect of the present invention, since the breakable part or the deformable part is broken or deformed while serving as a hinge, the electric wire can be smoothly guided, for example, at the time of a vehicle crash.

According to the fourth aspect of the present invention, since the breakable part or the deformable part is provided with a flange, the electric wire can be smoothly guided along the flange, for example, at the time of a vehicle crash.

### BRIEF DESCRIPTION OF DRAWINGS

FIG. 1 is a perspective view of a protector and an electric wire according to an embodiment of the invention before and after a fixation object is moved.

FIG. 2 is a perspective view which shows that the protector is assembled and fixed to the fixation object.

FIG. 3 is a perspective view of the protector and the electric wire when the fixation object is moved.

### DESCRIPTION OF EMBODIMENTS

A protector has an accommodating space for an electric wire or a bundle of electric wires, and the accommodating space includes an excessive part accommodating space for accommodating an excessive part of the electric wire or the bundle of electric wires. Further, the protector has a breakable part or a deformable part which is broken or deformed by being pushed by the electric wire or the bundle of electric wires.

### Embodiment

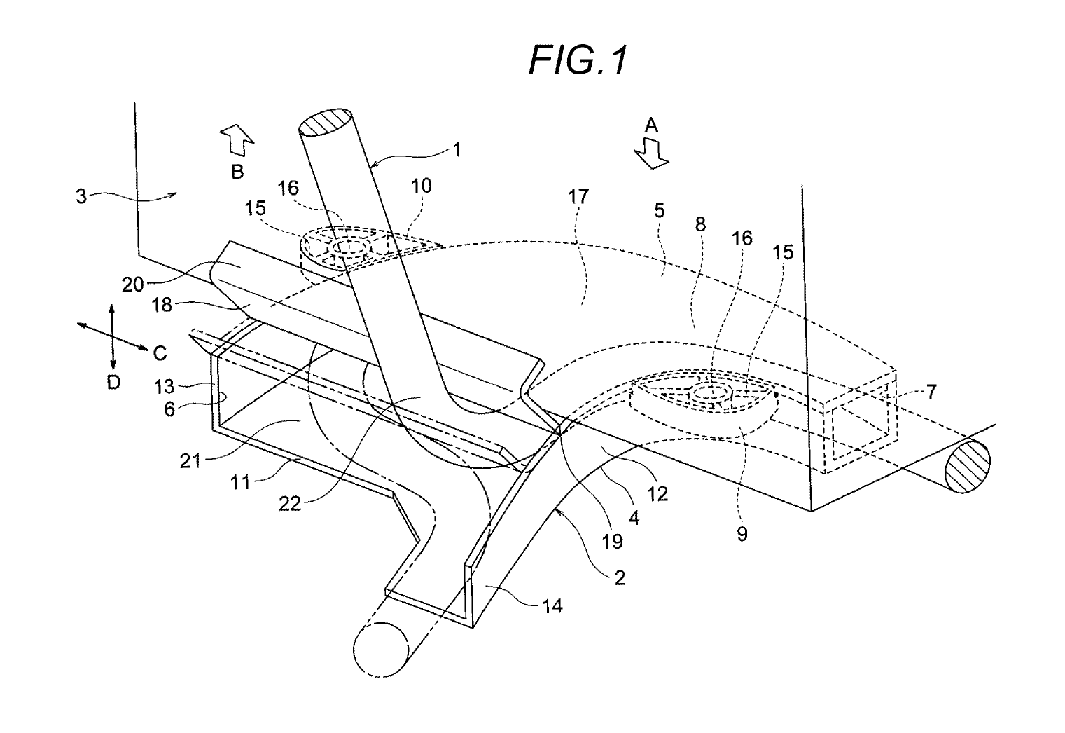

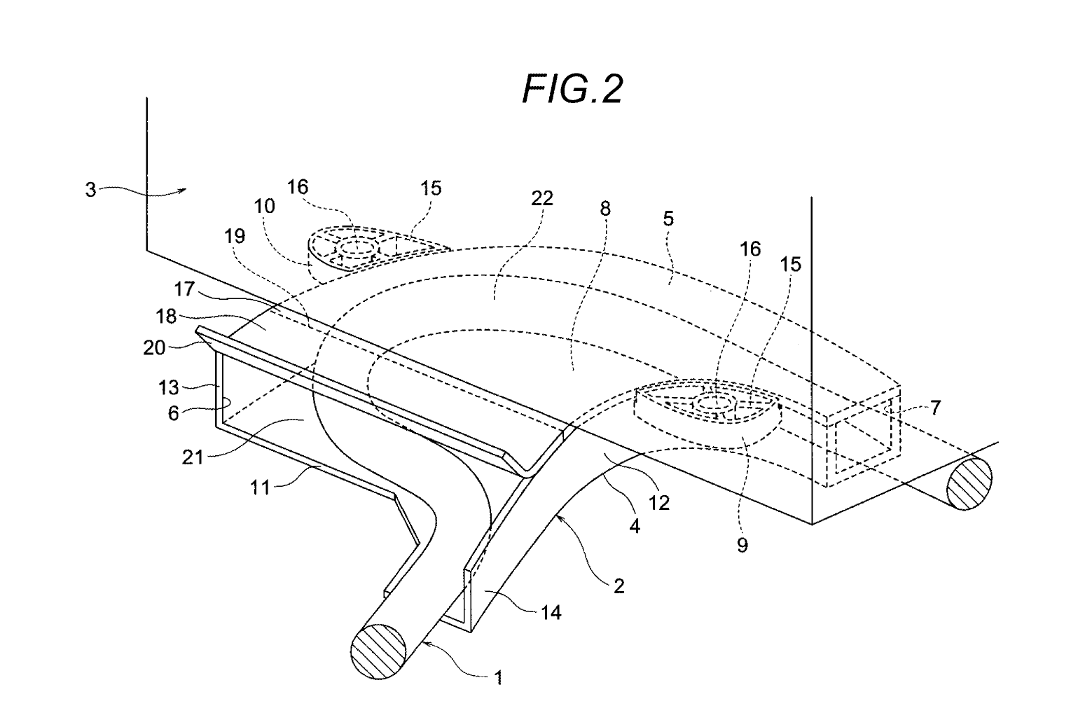

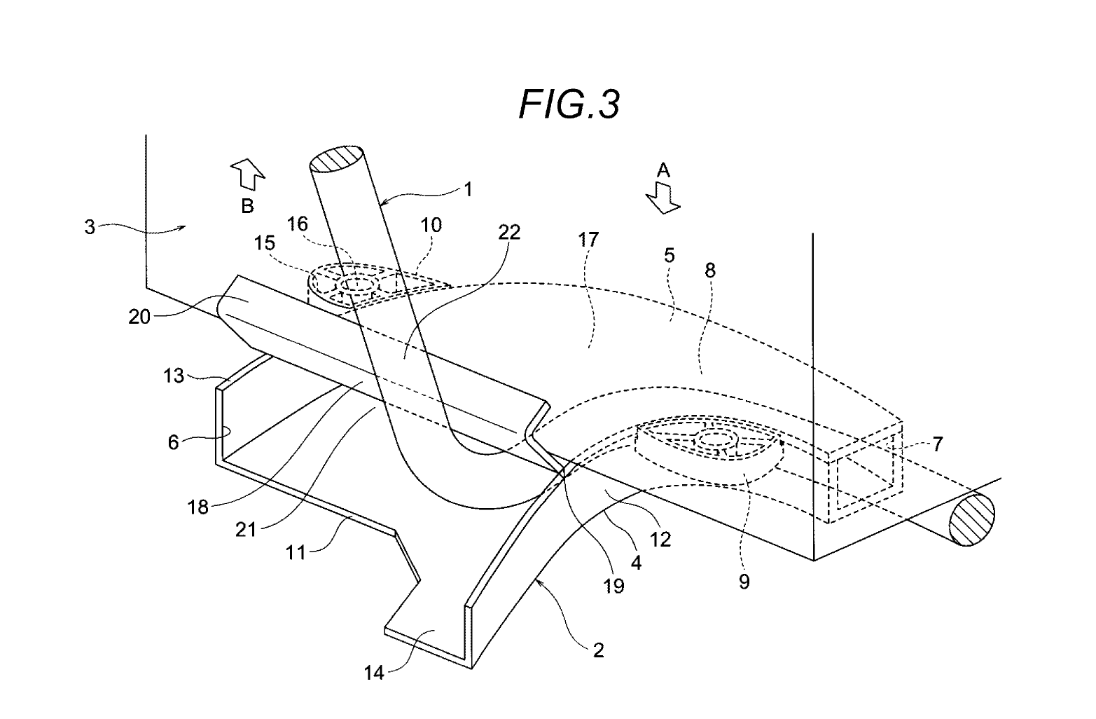

Below, an embodiment will be described with reference to the accompanying figures. FIG. 1 is a perspective view of a protector and an electric wire according to an embodiment of the invention before and after a fixation object is moved. FIG. 2 is a perspective view which shows that the protector is assembled and fixed to the fixation object. FIG. 3 is a perspective view of the protector and the electric wire when the fixation object is moved.

In the following description, specific shapes, materials, numerical values, directions are illustrations to facilitate the understanding of the present invention and should be changeable in accordance with applications, objects and specifications appropriately.

In FIG. 1, a wire harness which is arranged in a vehicle such as an automobile includes an electric wire 1 and connectors (not shown in the figure) for electrical connection that are provided at the terminals of the electric wire 1. The electric wire 1 is passed through and accommodated in the protector 2. The electric wire 1 may be replaced with a bundle of electric wires. The wire harness may be read as a harness.

The protector 2 is assembled and fixed to a predetermined position of a fixation object 3 in the vehicle when the electric wire 1 is passed through and accommodated in the protector 2. The protector 2 is assembled and fixed by using a bolt, for example, not shown in the figure. The fixation object 3 in this embodiment is provided for fixing the protector 2, but the fixation object 3 itself may not be necessarily fixed to any fixing tools.

The protector 2 is formed in such a shape that the arranging path of the electric wire 1 can be regulated. The protector 2 is formed in such a shape that the electric wire 1 can be protected from outside. The protector 2 can be seen from the following description. For example, the protector 2 is adapted to be able to allow the fixation object 3 to move at the time of a vehicle crash.

A direction which is indicated by an arrow A is a moving direction of the fixation object 3 at the time of the vehicle crash. The arrow A is an arrow pointing to the lower part of the figure, but actually the arrow A is an arrow which points from the front of vehicle to the rear of the vehicle. When the arrow A is an arrow which points to the rear, an arrow B is an arrow which points to the front.

In FIGS. 1 and 2, the protector 2 includes a generally groove-like protector body 4 which accommodates the electric wire 1 and a protector cover 5 which is engaged with the protector body 4. Both the protector body 4 and the protector cover 5 are molded of resin materials which are insulative. Although the protector body 4 and the protector cover 5 are formed separately in the embodiment, the protector body 4 and the protector cover 5 can be integrated by forming a hinge.

The protector 2 is formed when an opening at the front position of the protector body 4 which will be described later is covered by the protector cover 5. For the electric wire 1 is passed through and accommodated in the protector 2, the protector 2 is formed to have a first opening 6 from which the electric wire 1 is guided out (drawn out), and a second opening 7. For the electric wire 1 is passed through and accommodated in the protector 2, the protector 2 is formed to have an accommodating space 8 which is consecutive from the first opening 6 to the second opening 7. For the protector 2 is assembled and fixed to the predetermined position of the fixation object 3, the protector 2 is formed to have assembling and fixing parts 9 and 10.

The protector body 4 is formed to have a generally groove-like shape which opens at the front position (the upper part in the figure) and opens at the positions of the first opening 6 and the second opening 7. For the protector body 4 has the generally groove-like shape, the protector body 4 has a bottom wall 11 which serves as a rear surface (bottom side in the figure), and side walls 12 and 13 which raise at side edges of the bottom wall 11. The protector body 4 has a wire support 14 at the position of the first opening 6, and has the assembling and fixing parts 9 and 10 at the end edges of the side walls 12 and 13. The accommodating space 8 is formed between the bottom wall 11 and the side walls 12 and 13.

The first opening 6 is formed to open widely along a first intersection direction of an arrow C perpendicular to the axis of the electric wire 1. Further, the first opening 6 is formed so that an opening interval along a second intersection direction D perpendicular to the first intersection direction C becomes constant to match the diameter of the electric wire 1.

The wire support 14 is formed in the first opening 6. The wire support 14 is formed in such a shape to be a guide when the electric wire 1 is drawn out (guided out).

The second opening 7 is an opening which opens at a position opposite to the first opening 6, and is formed to have an opening size to match the diameter of the electric wire 1. The second opening 7 is formed to have an opening size that allows only one electric wire 1 to be guided out.

The side walls 12 and 13 are formed to curve. The distance between the side walls 12 and 13 is set to become narrow from the first opening 6 to the second opening 7. The assembling and fixing parts 9 and 10 which are provided at the side walls 12 and 13 have fixing surfaces 15 opposite to the predetermined position of the fixation object 3, and through holes 16 through which the bolts not shown in the figure are inserted.

The protector cover 5 is a generally board-like member and is formed in such a shape that the whole opening at the front position (the upper part in the figure) of the protector body 4 can be covered. The protector cover 5 and the protector body 4 are engaged with well-known locking structures such as locking protrusions and locking frames. The protector cover 5 has a cover body 17, a breakable part 18 and a slit 19 which serves as a boundary part between the cover body 17 and the breakable part 18.

The cover body 17 is formed as a part that is used to be pressed on the fixation object 3. The breakable part 18 is formed as a part which is broken by being pushed by the electric wire 1. The breakable part 18 is formed to have a generally cover-like shape which opens to the side of the fixation object 3 in the embodiment. The breakable part 18 is formed to be arranged near the first opening 6. The remaining thick part of the formed part of the slit 19 functions as a hinge. A flange 20 is formed at the end of the breakable part 18 (the formation of the flange 20 is arbitrary).

The following part may be formed to replace the breakable part 18. That is to say, a deformable part may be formed which is deformed by being pushed by the electric wire 1.

The breakable part 18 is formed so that an excessive part 22 of the electric wire 1 which is described later can be drawn out in a direction (direction of arrow B) generally opposite to the moving direction (direction of arrow A) of the fixation object 3, and the above break can be realized.

The accommodating space 8 has an excessive part accommodating space 21. The excessive part accommodating space 21 is formed as a space in which the excessive part 22 of the electric wire 1 is accommodated. The excessive part 22 is an excessive part of the electric wire 1, and the length of the excessive part 22 is set in consideration of the moving distance of the fixation object 3. The accommodating space 8 is formed so that only the part of the excessive part accommodating space 21 becomes larger. The accommodating space 8 is not a space in which only the electric wire 1 is accommodated, but is formed as a space which has the excessive part accommodating space 21 in consideration of the excessive part 22.

For the above composition and structure, as shown in FIG. 2, while the excessive part 22 is formed in the electric wire 1, the electric wire 1 is passed through and accommodated in the accommodating space 8 of the protector body 4, and then the opening at the front position (the upper part in the figure) of the protector body 4 is covered with the protector cover 5. Thus, the assembly of the electric wire 1 and the protector 2 is completed. Alternatively, while the electric wire 1 is passed through and accommodated in the accommodating space 8 of the protector body 4, the above opening of the protector body 4 is covered with the protector cover 5, and then the excessive part 22 is formed by pushing the electric wire 1 while the excessive part 22 is accommodated in the excessive part accommodating space 21. Thus, the assembly of the electric wire 1 and the protector 2 is completed.

The protector 2 is assembled and fixed to the predetermined position of the fixation object 3 in the vehicle when the electric wire 1 is passed through and accommodated in the protector 2. The electric wire 1 is drawn out from the position of the wire support 14 at the first opening 6 when the excessive part 22 is accommodated in the excessive part accommodating space 21.

In FIGS. 1 and 3, because the electric wire 1 has the excessive part 22 and the protector 2 has the excessive part accommodating space 21, for example, when it is considered that the fixation object 3 is to be moved in the arrow A direction at the time of vehicle crash, such a movement is allowed by the breakable part 18 which is broken by being pushed by the electric wire 1 and the drawing out of the excessive part 22. Because the movement of the fixation object 3 is not prevented since the excessive part 22 is drawn out and the electric wire 1 is not strained, the force at the time of the vehicle crash is not applied on the fixation object. As a result, the fixation object 3 is not damaged.

When the present embodiment is concluded, the protector 2 has the accommodating space 8 for the electric wire 1, and the accommodating space 8 includes the excessive part accommodating space 21 in which the excessive part 22 of the electric wire 1 is accommodated. Further, the protector 2 has the breakable part 18 which is broken when being pushed by the electric wire 1. The excessive part 22 of the electric wire 1 which is accommodated in the excessive part accommodating space 21 of the protector 2 is drawn out, for example, at the time of vehicle crash. The fixation object 3 is movable for the length of the excessive part 22. If the fixation object 3 is movable, the damage to the fixation object 3 can be relieved.

In addition, according to the present embodiment, because the breakable part 18 which is broken if an external force is received is provided, the fixation object 3 is movable further due to the breakable part 18. Therefore, the damage to the fixation object 3 is further relieved.

It is apparent that various modifications can be made to the invention without changing the purpose of the invention.

The present application is based upon and claims the benefit of Japanese application No. 2011-095820 filed on Apr. 22, 2011, the contents of which are incorporated by reference in its entirety.

### INDUSTRIAL APPLICABILITY

The protector in the embodiment is useful when the protector is provided in a movable body, such as a vehicle.

### REFERENCE SIGNS LIST

1: electric wire

2: protector

3: fixation object

4: protector body

5: protector cover

6: first opening (opening)

7: second opening (opening)

8: accommodating space

9, 10: assembling and fixing part

11: bottom wall

12, 13: side wall

14: wire support

15: fixing surface

16: through hole

17: cover body

18: breakable part

19: slit

20: flange

21: excessive part accommodating space

22: excessive part

1. A protector to be assembled and fixed to a given position of a fixation object, the protector comprising:
an accommodating space and an opening consecutive to the accommodating space which an electric wire or a bundle of electric wires is adapted to be passed through and accommodated in, wherein
the accommodating space includes an excessive part accommodating space which accommodates an excessive part of the electric wire or the bundle of electric wires.

2. The protector according to claim 1, wherein
a breakable part or a deformable part which is broken or deformed when being pushed by the electric wire or the bundle of the electric wires is provided in proximity to the opening which allows the excessive part to be drawn out from the excessive part accommodating space.

3. The protector according to claim 2, wherein
the breakable part or the deformable part is broken or deformed while serving as a hinge when being pushed by the electric wire or the bundle of the electric wires.

4. The protector according to claim 2, wherein
the breakable part or the deformable part is provided with a flange.
